(19) United States
(12) Patent Application Publication
(10) Pub. No.: US 2010/0097082 A1
(43) Pub. Date: Apr. 22, 2010

(54) APPARATUS AND METHOD FOR DETERMINING IN REAL TIME THE SUCCESS OF CONDUCTIVE COATING REMOVAL

(76) Inventors: George Panotopoulos, Berkeley, CA (US); Philip Liu, Fremont, CA (US)

Correspondence Address: WEISS & MOY PC, 4204 NORTH BROWN AVENUE, SCOTTSDALE, AZ, 85251, US

(21) Appl. No.: 12/253,096

(22) Filed: Oct. 16, 2008

(51) Int. Cl. G01N 27/04

(52) U.S. Cl. 324/693

(57) ABSTRACT

An apparatus and method is provided for determining, using real-time data, whether a removal process has been effective in removing a conductive coating from a removal site on a substrate of an electric device. The method includes determination of conductivity between the removal site and the intact conductive coating which relates to the absence or presence of the conductive coating in the removal site. The presence of conductive coating in the removal site indicates incomplete removal and thus enables real time correction thereof.

### FIELD OF THE INVENTION

This invention relates generally to the removal of a conductive coating from electric devices or parts thereof. More specifically, this invention relates to an apparatus and method for detecting in real time incomplete removal of conductive coating to permit correction thereof.

### BACKGROUND OF THE INVENTION

Electric devices may be used for many applications such as optoelectronic devices, ground planes for photoreceptors and electrographic imaging members, electrodes in solar cells, electrical shieldings for electronic devices, stable electrodes for other electronic devices, and the like. An electric device as referred to herein comprises a substrate and one or more electrically conductive layers comprising a conductive film. The conductive film or coating may be either a single material film or a stack of films with conductive properties.

The substrate may comprise any suitable rigid or flexible member. The substrate may be opaque or substantially transparent and may comprise numerous suitable materials having the required mechanical properties. For example, it may comprise an electrically insulating support layer. Typical underlying flexible support layers include insulating or non-conducting materials comprising various film forming polymers or mixtures thereof with or without other suitable materials. Typical polymers include, for example, polyesters, polycarbonates, polyamides, polyurethanes, and the like. The supporting substrate layer carrying the electrically conductive layer may have any number of different configurations such as, for example, a sheet, a cylinder, a scroll, an endless flexible belt, and the like.

A conductive coating may be used as an interconnect between layers of electric devices. A conductive coating (single or stack of films) is also used on electric devices to provide protection and extend their life in harsh environments. Such devices may be fabricated by depositing the conductive film or coating on the substrate. There are several different types of conductive coatings, each developed to suit specific applications. Depending on the coating material and product requirements, a conductive coating may be applied by dipping, brushing, spraying, dispensing, electroplating, sputtering or chemical vapor deposition including plasma enhanced chemical vapor deposition.

The conductive coating must often be removed in specific areas to define desired conductive paths or to insulate the electric device from its surroundings. One such area from which the conductive coating must be removed is from the edge of the device and its removal therefrom is referred to herein as “edge deletion.” For example, U.S. patent application Ser. No. 11/947,543 filed Nov. 29, 2007 and having a common inventor to the invention described herein describes removal of a conductive coating (in this case a full stack of films (the so-called “functional stack”)) from the edge of a substrate to define a border zone on an optoelectronic device (a solar panel).

The most commonly used processes for removal of conductive coatings involve abrasion, bead blasting, laser ablation, or some other removal process. In the bead blasting process, a precise mixture of dry air or an inert gas and an abrasive media (such as glass beads) is propelled through a nozzle attached to a bead blasting head which is either hand held or mounted on an automatic system. This allows the mixture to be focused at the target area of the conductive coating to be removed (the so-called “removal site”). A vacuum system continuously removes the used materials and channels them through a filtration system for disposal. This process is sometimes conducted within an enclosed anti-static work chamber which includes grounding devices to dissipate electrostatic potential. The nature and size of this media, and the pressure and velocity of the air or inert gas stream, will influence the degree to which the substrate will be blasted, and the nature of the end result. With laser ablation, the conductive coating may be removed from the substrate by irradiating the target area with a laser beam from a laser deflected off a galvo mirror.

Unfortunately, the conductive coating on the substrate may not be completely removed from the removal site on the substrate during the removal process causing an increased number of device failures and scrapped devices resulting in a decreased yield of suitable devices. Moreover, as failure is typically not determined until after the device has been fully processed, the source of the failure is often untraceable. Moreover, such failures often result in delaying processing of the device.

Accordingly, there has been a need for a novel apparatus and method that detect in real time incomplete removal of the conductive coating thereby permitting correction thereof while the device is still being processed. There is a further need for a novel apparatus and method that permit real time recovery from failures during processing of the devices resulting in decreased scrap and increased yield of the devices. There is a further need for an apparatus and method that enable real-time determination of the source of failures. The present invention fulfills these needs and provides other related advantages.

### SUMMARY OF THE INVENTION

The present invention resides in an apparatus and method for detecting in real time incomplete conductive coating removal allowing real time correction thereof. The apparatus comprises, generally, a first probe adapted to be electrically connected to a conductive coating of a substrate of an electric device; a second probe adapted to be contacted with a removal site on the substrate from which the conductive coating has just been removed by a removal device, the removal device disposed between the first and second probes; and a measuring instrument connected to said first and second probes to measure the current flow or the resistance to current flow between the first and second probes which correlates with whether conductive coating is present or absent on the removal site. The apparatus may further comprise a control unit for comparing the measured conductivity against a threshold value to determine if conductive coating is present or absent on the removal site.

The first and second probes may be spaced as closely as possible without being affected by the removal device and so that they are electrically connected when removal is unsuccessful. The first and second probes or the second probe only may be mounted on the head of the removal device.

The removal device is that used in conventional removal processes such as bead blasting, laser ablation, etc.

The measuring instrument includes a meter such as a multimeter, ohmmeter, ampmeter, voltmeter, ammeter or the like which measures the direct current (flow of electric charges) or resistance through an electric circuit.

The control unit may be selected from one or more of a computer (FIG. 4), PLC, microprocessor, Field-Programmable Gate Array (FPGA) or the like. The control unit may be configured to compare the measured conductivity against a threshold value and correct or adjust processing parameters.

A removal device actuator as used in conventional removal processes may move the removal device along a linear removal path of the substrate leaving behind the removal site at any given point in time. In the case of the laser ablation removal process, the removal device actuator adjusts the position of the galvo mirror to move the laser beam along the removal path in the direction of travel/process. When the first and second probes are mounted on the removal device head, the removal device actuator controls motion of both the removal device and associated probes.

When the first and second probes are separate from the removal device head, a probe actuator moves the probes in coordinated motion with the removal device actuator. At any given time, the first probe precedes or leads the removal device with the second probe trailing behind the removal device. The first probe may move with the removal device or be static with the second probe trailing behind the removal device. If the first probe is to be static, the second probe may be mounted on the blasting head without the first probe.

It is also possible that the removal device with or without the probes may be static with the substrate moving in the direction of process.

Current induced from a voltage potential may be supplied across the first and second probes. Current from the first probe passes through the conductive coating (if present) to the second probe to establish an electrical circuit.

The measuring instrument measures the current flow or resistance to current flow between the first and second probe continuously during processing. This action generates a conductivity signal directly, or a resistance signal indirectly, which may be displayed on the measuring instrument included in the circuit or sent to a suitable remote control unit.

The control unit may determine whether the current flow or the resistance to current flow between the first and second probes is indicative of the presence or absence of conductive coating on the removal site. The control unit may compare the current flow induced by the voltage potential or the resistance to current flow between the first and second probes to a threshold value. If the removal of the conductive coating on the removal site is successful, the resistance between the first and second probes will be very high. Accordingly, if the conductivity identified by the current induced between the first and second probes is less than the threshold value, any conductive coating present in the removal site from where the conductive coating has just been removed is not significant and removal therefrom is determined to be complete. In this case, the control unit permits the removal device to continue normal operation by continuing to remove the conductive coating along the removal path.

If removal is unsuccessful (incomplete removal), the residual conductive coating on the removal site will present a conductive path between the first and second probe i.e. if the conductivity identified by the current induced between the probes is greater than the threshold value, removal is deemed to be incomplete and the removal site is deemed in need of farther processing.

If the presence of conductive coating on the removal site is detected by the control unit, the control unit can modify the mode of operation of the removal device or other processing parameters may be adjusted to further remove the conductive coating from the removal site while the electric device is still in process.

It is therefore an object of the invention to provide real time monitoring of the conductive coating removal process enabling real time correction thereof.

It is a further object of the invention to use real-time data to determine that the conductive coating in the removal site has not been completely removed permitting further removal on that site to be done immediately without processing delay.

It is another object of the invention to determine the source of any failure in real time, which results in fewer failures and scrapped devices.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a simplified view of an electric device and a first probe electrically connected to the conductive upper surface of the device and a second probe adapted to be electrically connected to the first probe with a removal device disposed between the first and second probes;

FIG. 2 is an operational view of the method of the invention, illustrating the first probe ahead of the exemplary bead blasting removal device as the removal device or substrate moves in the direction of travel indicated by the arrow and being electrically connected to the conductive coating of the substrate and the second probe trailing the bead blasting removal device and making contact with a removal site on the substrate of the electric device from where the conductive coating has just been removed, the complete removal of the conductive coating from the removal site breaking the electrical circuit between the first and second probes;

FIG. 3 is an operational view similar to FIG. 2, illustrating the first and second probes mounted on the blasting head structure;

FIG. 4 is a perspective view of the apparatus of the invention, illustrating an exemplary measuring instrument connected to the first and second probes to measure conductivity; and an exemplary control unit; and

FIG. 5 is a simplified view of the apparatus using a laser ablation removal process, illustrating a laser beam from a laser deflected with a galvo mirror with the removal device disposed between the first and second probes.

### DETAILED DESCRIPTION OF THE PREFERRED EMBODIMENTS

As shown in the drawings for purposes of illustration, the present invention is concerned with an improved apparatus and method for detecting incomplete removal of a conductive coating from a removal site on a substrate, the apparatus generally designated in the accompanying drawings by the reference number 10. The apparatus 10 comprises, generally, a first probe 12 adapted to be electrically connected to a conductive coating 14 of a substrate 16 of an electric device 18; a second probe 20 adapted to be contacted with a removal site 22 on the substrate from which the conductive coating has just been removed by a removal device 24, the removal device 24 disposed between the first and second probes 12 and 20; and a measuring instrument 26 connected to said first and second probes to measure the current flow or the resistance to current flow between the first and second probes which correlates with whether conductive coating is present or absent on the removal site. The apparatus may further comprise a control unit 28 for comparing the measured conductivity against a threshold value to determine if conductive coating is present or absent on the removal site.

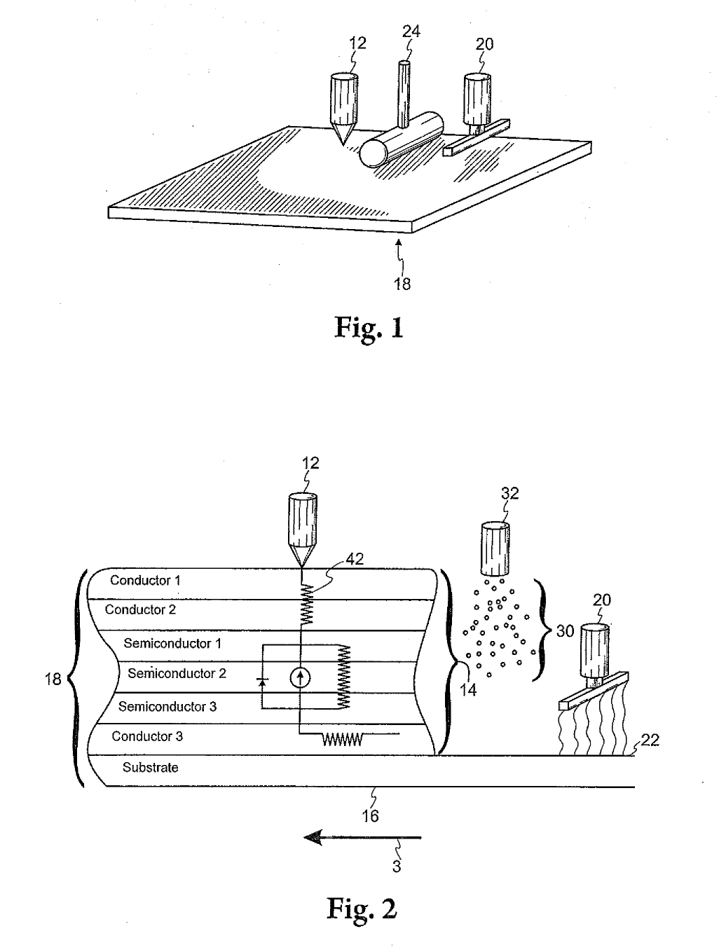

In accordance with the present invention, and as illustrated with respect to a preferred embodiment in FIGS. 1-5, the apparatus and method provide real time monitoring of the conductive coating removal process enabling real time correction thereof. Using real-time data to determine that the conductive coating in the removal site has not been completely removed permits further removal on that site to be done immediately without processing delay, the source of the failure may be determined substantially simultaneously allowing immediate correction, which results in fewer failures and scrapped devices.

The term “electric device” as used herein comprises a substrate and one or more electrically conductive layers comprising a conductive film or coating. The conductive film or coating may be either a single material film or a stack of films with conductive properties. There are many applications for electric devices as previously described.

The term “substrate” as used herein means any suitable rigid or flexible member. The substrate may be opaque or substantially transparent and may comprise numerous suitable materials having the required mechanical properties. For example, it may comprise an electrically insulating support layer. Typical underlying flexible support layers include insulating or non-conducting materials comprising various film forming polymers or mixtures thereof with or without other suitable materials. Typical polymers include, for example, polyesters, polycarbonates, polyamides, polyurethanes, and the like. The supporting substrate layer carrying the electrically conductive layer may have any number of different configurations such as, for example, a sheet, a cylinder, a scroll, an endless flexible belt, and the like.

The term “conductive coating” as used herein means one or more electrically conductive layers. The conductive film or coating may be either a single material film or a stack of films with conductive properties. Many conductive coatings are well known in the art.

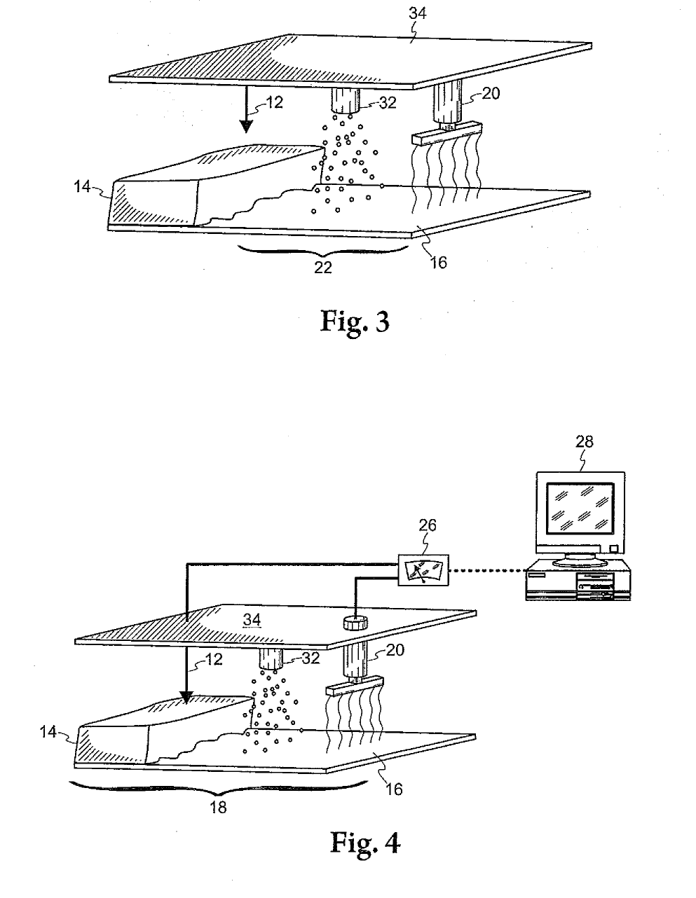

The first and second probes 12 and 20 may be spaced as closely as possible without being affected by the removal device and so that they are electrically connected when removal is unsuccessful as hereinafter described. The size and type of probes may be varied. In a preferred embodiment as shown in FIGS. 1 and 2, the first probe 12 comprises a point electrode and the second probe 20 comprises a wide electrode. FIGS. 2 and 3 show a copper brush electrode as the second probe 20. As shown in FIG. 2, the first probe 12 is electrically connected to the entire area of the conductive coating 14 and therefore its size may change without affecting processing. It is preferred that the second probe 20 be a wide probe capable of adequately covering the target area of the conductive coating that is to be removed, however, narrower second probes are included within the scope of this invention. The first and second probes may also be the same size which lowers the number of parts that need to be kept on hand. While a point electric probe and a wide copper brush electric probe are shown, other types of probes may be used within the confines of the invention. Exemplary probes include conductive foam probes, polymer probes (available from, for example, Chomerics, Woburn, Mass.), soft electrodes, graphite electrodes, radiofrequency (RF) electrodes or the like. Both contact and non-contact probes may be used within the confines of the invention.

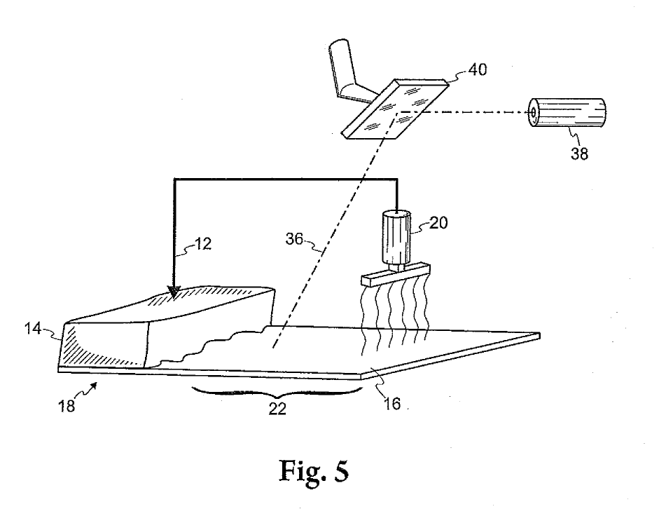

The removal device 24 is that used in conventional removal processes such as bead blasting, laser ablation, etc. FIG. 1 shows a simplistic view of a removal device 24 positioned between the first and second probes 12 and 20. In the bead blasting removal process, blasting media 30 is typically dispersed from a nozzle 32 disposed in a blasting head 34 attached to a stylus (not shown). The nozzle 32 may be disposed between the first and second probes as shown in FIG. 3. The first and second probes 12 and 20 may be separate from the blasting head 34 as shown in FIGS. 1 and 2 or may be mechanically mounted on the blasting head 34 as shown in FIGS. 3 and 4. Alternatively, just the second probe 20 may be mechanically mounted on the blasting head. In the laser ablation process shown in FIG. 5, the conductive coating 14 is removed from the substrate 16 by irradiating it with a laser beam 36 from a laser 38 deflected off a galvo mirror 40. The laser beam 36 may be directed between the first and second probes 12 and 20. While bead blasting and laser ablation processes are described, other conventional removal processes using process heads between the first and second probes are within the confines of the invention.

The measuring instrument 26 (FIG. 4) includes a meter such as a multimeter, ohmmeter, ampmeter, voltmeter, ammeter or the like which measures the direct current (flow of electric charges) or resistance through an electric circuit.

The control unit 28 may be selected from one or more of a computer (FIG. 4), PLC, microprocessor, Field-Programmable Gate Array (FPGA) or the like. The control unit may be configured to compare the measured conductivity against a threshold value and correct or adjust processing parameters as hereinafter described. While the measuring instrument 26 and control unit 28 are shown in FIG. 4 associated with a blasting removal process, it is to be appreciated that the measuring instrument 26 and control unit 28 may be used with other conductive coating removal processes including laser ablation or the like.

A removal device actuator (not shown) as used in conventional removal processes moves the removal device 24 along a linear removal path (e.g. the edge for edge deletion) of the substrate leaving behind the removal site 22 at any given point in time. The direction of process or travel is indicated by the arrow 3 in FIG. 2. In the case of the laser ablation removal process as shown in FIG. 5, the removal device actuator (not shown) adjusts the position of the galvo mirror 40 to move the laser beam 36 along the removal path in the direction of process. When the first and second probes 12 and 20 are mounted in the removal device head, the removal device actuator controls motion of both the removal device and associated probes.

When the first and second probes 12 and 20 are separate from the removal device head as shown in FIGS. 1 and 2, a probe actuator (not shown) moves the probes in coordinated motion with the removal device actuator. For example, the probe actuator is synchronized with the galvo mirror actuator. At any given time, the first probe 12 precedes or leads the removal device 24 with the second probe 20 trailing behind the removal device. The first probe 12 may move with the removal device 24 or be static with the second probe 20 trailing behind the removal device. If the first probe is to be static, the second probe may be mounted on the blasting head without the first probe. It is also to be appreciated that the removal device and probes may be static with the substrate moving in the direction of process 3.

Current 42 (FIG. 2) induced from a voltage potential may be supplied across the first and second probes. Current from the first probe passes though the conductive coating (if present) to the second probe to establish an electrical circuit. The conductive coating may exhibit different conductivities depending of the polarity of the applied voltage.

The measuring instrument 26 measures the current flow or resistance to current flow between the first and second probe continuously during processing. This action generates a conductivity signal directly, or a resistance signal indirectly, which may be displayed on the measuring instrument 26 included in the circuit or sent to a suitable remote control unit 28 (FIG. 4).

In applications where the conductive coating removal process removes the all conductive layers such as described in U.S. patent application Ser. No. 11/947,543 filed Nov. 29, 2007 in which the full photovoltaic functional stack there (i.e. the conductive coating) was removed, the stack will exhibit considerably higher conductivity to current flowing from bottom to top, so positive test voltage should be applied to the leading probe 12 and negative test voltage to the trailing probe 20, as shown in FIG. 2.

The control unit 28 may determine whether the current flow or the resistance to current flow between the first and second probes 12 and 20 is indicative of the presence or absence of conductive coating on the removal site. The control unit may compare the current flow induced by the voltage potential or the resistance to current flow between the first and second probes to a threshold value. If the removal of the conductive coating on the removal site is successful, the resistance between the first and second probes will be very high. Accordingly, if the conductivity identified by the current induced between the first and second probes is less than the threshold value, any conductive coating present in the removal site from where the conductive coating has just been removed is not significant and removal therefrom is determined to be complete. In this case, the control unit permits the removal device to continue normal operation by continuing to remove the conductive coating along the removal path.

On the other hand, if removal is unsuccessful (incomplete removal), the residual conductive coating on the removal site will present a conductive path between the first and second probe i.e. if the conductivity identified by the current induced between the probes is greater than the threshold value, removal is deemed to be incomplete and the removal site is deemed in need of further processing.

If the presence of conductive coating on the removal site (i.e. after supposed removal) is detected by the control unit, the control unit can modify the mode of operation of the removal device or other processing parameters may be adjusted to further remove the conductive coating from the removal site while the electric device is still in process. The removal device may be returned to the removal site for one or more passes. Process parameters such as bead pressure, head, angle of the head, etc. may be adjusted or changed if incomplete removal is detected. Correction (e.g. further removal and adjustment) may occur just after the initial removal (albeit incomplete removal) of the conductive coating from the removal site so that processing is minimally delayed. If film removal involves a consumable removal device (e.g. a Dremel® head), incomplete removal may indicate that replacement thereof may be necessary.

From the foregoing, it is to be appreciated that the apparatus and method of the present invention provides real time monitoring of the removal process enabling real time correction thereof. Using real-time data to determine that the conductive coating in the removal site has not been completely removed permits further removal on that site to be done immediately without processing delay, the source of the failure may be determined substantially simultaneously allowing immediate correction, which results in fewer failures and scrapped devices.

Although a particular embodiment of the invention has been described in detail for purposes of illustration, various modifications may be made without departing from the spirit and scope of the invention. Accordingly, the invention is not to be limited, except as by the appended claims.

We claim:

1. An apparatus for detecting in realtime incomplete conductive coating removal from a substrate of an electric device comprising:
a first probe adapted to be electrically connected with a conductive coating of a substrate of an electric device;
a second probe adapted to be in contact with a removal site on the substrate from where the conductive coating had just been purportedly removed with a removal device, with one of the substrate and the removal device moving in a direction of process, the removal device disposed between the first and second probes; and
a measuring instrument connected to said first and second probes to measure the current flow or the resistance to current flow between the first and second probes, the conductivity measurement correlating to the presence or absence of conductive coating on the removal site, the presence of conductive coating thereon indicating incomplete conductive coating removal.

2. The apparatus of claim 1 further comprising a control unit for comparing the measured conductivity against a threshold value for determining the absence or presence of the conductivity coating on the removal site.

3. The apparatus of claim 2 wherein a measured conductivity less than the threshold value indicates removal of conductive coating from the removal site is complete and a measured conductivity greater than the threshold value indicates incomplete removal of conductive coating from the removal site.

4. The apparatus of claim 1 wherein the control unit further adjusts processing parameters of a conductive coating removal process if the presence of the conductivity coating on the removal site is determined.

5. The apparatus of claim 1 wherein at least one of the first and second probes are mounted on a removal device head.

6. The apparatus of claim 1 wherein the first and second probes respectively make surface contact with the conductivity coating and the removal site.

7. The apparatus of claim 1 wherein the removal device comprises one of a media blaster head and a laser beam from a laser.

8. The apparatus of claim 1 wherein the first probe is a narrow probe and the second probe is a wide probe.

9. The apparatus of claim 1 further comprising at least one probe actuator for moving at least the second probe in the direction of process trailing behind the removal device.

10. A method for determining in real time whether the conductive coating from a substrate of an electric device has been completely removed, comprising the steps of:
electrically connecting a first probe with the conductive coating of the substrate of the electric device;
positioning a second probe over the conductive coating in a position adapted to be electrically connected to the first probe;
positioning a removal device between the first and second probes;
removing at least a portion of the conductive coating on the substrate by moving one of the removal device and the substrate along a removal path, wherein said second probe becomes disposed over the removal site of the substrate from where the conductive coating has just purportedly been removed;
measuring in real time the current or the resistance to current between the first and second probes;
comparing the conductivity measurement against a threshold value, wherein a measured conductivity less than the threshold value indicates removal of conductive coating from the removal site is complete and a measured conductivity greater than the threshold value indicates incomplete removal of conductive coating from the removal site.

11. The method of claim 10 further comprising the step of returning the removal device to the removal site for further removal of the conductive coating.

12. The method of claim 10 further comprising the step of modifying the mode of operation of the removal device.

13. The method of claim 10 further comprising the step of adjusting the process parameters of the removal device.

14. The method of claim 10 wherein at least one of the first and second probes are mounted on a removal device head.

15. The method of claim 10 wherein the first and second probes respectively make surface contact with the conductive coating and the removal site.

16. The method of claim 10 wherein the removal device comprises one of a media blaster head and a laser beam from a laser.

17. The method of claim 10 wherein a removal actuator moves the removal device in the direction of process.

18. The method of claim 17 wherein the first and second probe are mounted on the removal device and the removal actuator moves the removal device and associated first and second probes.

19. The method of claim 17 wherein a probe actuator moves the second probe in a direction trailing behind the removal device.

20. The method of claim 19 wherein the probe actuator further moves the first probe to lead the removal device.
